(19) United States
(12) Patent Application Publication
(10) Pub. No.: US 2017/0173519 A1
(43) Pub. Date: Jun. 22, 2017

(54) DESULFURIZATION DEVICE

(71) Applicant: IHI Corporation, Koto-ku (JP)

(72) Inventor: Toshiyuki NAITO, Koto-ku (JP)

(73) Assignee: IHI Corporation, Koto-ku (JP)

(21) Appl. No.: 15/449,050

(22) Filed: Mar. 3, 2017

Related U.S. Application Data
(63) Continuation of application No. PCT/JP2015/064382, filed on May 19, 2015.

(30) Foreign Application Priority Data
Sep. 4, 2014 (JP) 2014-179821

(51) Int. Cl. B01D 53/18; B01D 53/14; B01D 53/50

(52) U.S. Cl. CPC B01D 53/18; B01D 53/507; B01D 53/1481; B01D 2251/404

(57) ABSTRACT

A liquid collection plate is arranged in an absorbing column between a spray unit and a reservoir and has a hollow frustoconical shape with a descending slope from an outer periphery thereof toward an axis thereof and having an axial bottom with an opening immersed in the absorption liquid in the reservoir. The liquid collection plate is peripherally divided into and formed by a plurality of divisional plates. Each of the divisional plates has an outer upper end with a hook supported by a latch on an inner surface of the absorbing column and has an inner lower end supported by a brace fixed to a bottom of the reservoir.

### TECHNICAL FIELD

The present disclosure relates to a desulfurization device for an oxyfuel combustor.

### BACKGROUND ART

Usually, air combustion is employed for a common pulverized coal boiler. Exhaust gas discharged from the pulverized coal boiler contains sulfur dioxide (SO₂) so that a desulfurization device is arranged downstream of the pulverized coal boiler to desulfurize the exhaust gas and reduce a concentration of sulfur dioxide (SO₂) in the exhaust gas to no more than a predetermined value. The desulfurization device usually employed for the common pulverized coal boiler is a wet-type desulfurization device concerned with a so-called limestone-gypsum process.

In such a desulfurization device, the exhaust gas discharged from the pulverized coal boiler and containing sulfur dioxide (SO₂) is contacted with absorption liquid containing limestone (CaCO₃) to make recovery in the form of gypsum (CaSO₄). Thus, in order to oxidize sulfur dioxide in the exhaust gas and make recovery in the form of gypsum, oxidizing air is blown into the absorption liquid stored in a reservoir in the desulfurization device.

On the other hand, an oxyfuel combustion pulverized coal boiler has been recently developed which employs oxyfuel combustion.

In the oxyfuel combustion pulverized coal boiler, which discharges the exhaust gas mainly constituted by carbon dioxide, work-load can be reduced in a recovery work of guiding the exhaust gas to a carbon dioxide recovery unit to recover carbon dioxide.

Also in the oxyfuel combustion pulverized coal boiler, the exhaust gas contains, in addition to carbon dioxide as a main component, coal-derived sulfur dioxide which is to be removed by a desulfurization device. Specifically, the exhaust gas discharged from the oxyfuel combustion pulverized coal boiler is guided downstream to the carbon dioxide recovery unit where carbon dioxide is liquefied through compression cooling; the sulfur dioxide, when included in the exhaust gas, is liquefied in the cooling process of the exhaust gas into sulfuric acid which may corrode components in the carbon dioxide recovery unit. Thus, the exhaust gas from the oxyfuel combustion pulverized coal boiler is treated by the desulfurization device so as to minimize a concentration of sulfur dioxide remaining in the exhaust gas.

However, when oxidizing air is blown into the absorption liquid in the reservoir in the wet-type desulfurization device for oxidization of sulfur dioxide as mentioned in the above, the oxidizing air is mixed with the exhaust gas mainly constituted by carbon dioxide, resulting in lowering a purity of carbon dioxide in the exhaust gas. The lowering in purity of carbon dioxide in the exhaust gas brings about a problem of increased work-load in guiding the exhaust gas into the carbon dioxide recovery unit for recovery of carbon dioxide.

In order to overcome this, a desulfurization device for use in an oxyfuel combustion pulverized coal boiler has been proposed which is devised to prevent oxidizing air blown into the absorption liquid from being mixed with the exhaust gas containing carbon dioxide as the main component (Patent Literature 1).

In Patent Literature 1, the exhaust gas is introduced into an absorbing column with a spray unit and is contacted with absorption liquid injected by the spray unit. Arranged below the absorbing column is a reservoir which surrounds a lower portion of the absorbing column to recover the absorption liquid. The lower portion of the absorbing column is in the form of a seal tube which has a lower end extending adjacent to an inner bottom of the reservoir to partition an inside of the reservoir. The reservoir is provided with an stirrer which stirs the absorption liquid in the reservoir. The stirrer stirs limestone particles in the absorption liquid and swirls the absorption liquid in the reservoir along an outer periphery of the seal tube. Arranged adjacent to the stirrer is an air supply pipe which blows the oxidizing air into the absorption liquid.

In the Patent Literature 1, the inside of the reservoir is partitioned into portions inward and outward of the seal tube so that the oxidizing air blown by the air supply pipe into the absorption liquid in the reservoir rises, in the absorption liquid between an outer surface of the seal tube and an inner surface of the reservoir. Thus, the oxidizing air is prevented from being directed an inside of the seal tube to prevent the oxidizing air from being mixed with the exhaust gas within the absorbing column.

### CITATION LIST

### Patent Literature

Patent Literature 1: US 2013/0055937A

### SUMMARY

### Technical Problems

The desulfurization device arranged for the oxyfuel combustion pulverized coal boiler is provided with a partition wall structure such as the seal tube shown in the Patent Literature 1 which prevents the oxidizing air blown into the absorption liquid in the reservoir from flowing into the absorbing column. As a result, in Patent Literature 1, the absorbing column integral with the seal tube is suspended in a specified height such that a lower end of the seal tube is spaced apart from the inner bottom of the reservoir, which brings about a problem that the inner structure of the reservoir becomes complicated. Moreover, used is a support structure with high stiffness and strength to support the absorbing column above the reservoir.

The inside of the reservoir is partitioned by the seal tube to prevent the oxidizing air from invading into the seal tube so that any oxidization of the absorption liquid within the seal tube cannot be expected. Thus, there is a problem that oxidizing effect in the reservoir as a whole is suppressively low.

In the desulfurization device, there is a further problem that a great amount of gypsum adheres to insides of the absorbing column and reservoir and to the spray unit. Thus, the desulfurization device is periodically shut down to conduct a maintenance work of removing any adhering gypsum, inspecting any occurrence of corrosion and repairing any portions to be repaired. On an occasion of the maintenance work in the desulfurization device, the absorption liquid in the reservoir is wholly removed to assemble a scaffolding within the reservoir and absorbing column and conduct work of removing any gypsum adhering to the insides of the reservoir and absorbing column as well as to the spray unit. Moreover, any corrosion on the inner surfaces of the reservoir and absorbing column and the spray unit is inspected to conduct repair any portions to be repaired.

However, in the structure with the partition wall such as the seal tube being arranged in the reservoir, assembling the scaffolding becomes much difficult so that it takes a lot of time to conduct the maintenance work in the desulfurization device, resulting in increased expense for the maintenance work.

Thus, there exists no desulfurization device for a common oxyfuel combustion pulverized coal boiler which is constructed with consideration for a maintenance work.

The disclosure was made in view of the above and has its object to provide a desulfurization device which enables, with a simple structure, partitioning to prevent oxidizing air blown into a reservoir from being mixed with exhaust gas in an absorbing column and enables an easy maintenance work for the desulfurization device.

### Solution to Problems

The disclosure is directed to a desulfurization device comprising
an absorbing column into which introduced is exhaust gas from an oxyfuel combustor, the absorbing column comprising a spray unit, a reservoir for storing absorption liquid injected from the spray unit and contacted with the exhaust gas, a stirrer for stirring and swirling the absorption liquid in the reservoir peripherally and an air supply pipe for blowing oxidizing air into the absorption liquid in the reservoir and
a liquid collection plate arranged in the absorbing column between the spray unit and the reservoir, the liquid collection plate having a hollow frustoconical shape with a descending slope from an outer periphery thereof toward an axis thereof and having an axial bottom with an opening positioned in the absorption liquid of the reservoir,
the liquid collection plate being peripherally divided into and formed by a plurality of divisional plates, each of the divisional plates having an outer upper end with a hook supported by a latch on an inner surface of the absorbing column and having an inner lower end supported by a brace fixed to a bottom of the reservoir.

In the above-mentioned desulfurization device, a radially extending reinforcing frame may be fixed on each of the divisional plates and may have a lower end extending beyond the inner lower end of the corresponding divisional plate to provide an insert which is inserted into and supported by an upper end of the brace.

In the above-mentioned desulfurization device, liquid-guiding projections may be arranged on an upper surface of the liquid collection plate to swirl the absorption liquid injected from the spray unit in a direction same as that of swirl of the absorption liquid in the reservoir by the stirrers and guide the absorption liquid into the opening.

### Effects

The desulfurization device according to the disclosure has excellent effects that partitioning can be made by a simply constructed liquid collection plate to prevent oxidizing air blown into a reservoir from being mixed with exhaust gas in an absorbing column and that a maintenance work of the desulfurization device is facilitated by dismounting divisional plates.

### BRIEF DESCRIPTION OF DRAWINGS

FIG. 1 is an overall schematic side view showing an embodiment of a desulfurization device according to the disclosure applied to an oxyfuel combustion coal boiler as an oxyfuel combustor;

FIG. 2a is a schematic side view showing a portion in FIG. 1 in enlarged scale;

FIG. 2b is a plan view looking in a direction of IIB-IIB in FIG. 2a;

FIG. 3a is a sectional view showing an example of a reinforcing frame attached to a divisional plate;

FIG. 3b is a sectional view showing a further example of the reinforcing frame attached to the divisional plate;

FIG. 3c is a sectional view showing a liquid-guiding plate as a liquid-guiding projection fixed to an upper surface of the divisional plate; and

FIG. 4 is a plan view showing the liquid-guiding plates as the liquid-guiding projections on the upper surface of the liquid collection plate which are different in shape from those in FIG. 2b.

### DESCRIPTION OF EMBODIMENT

An embodiment of the disclosure will be described in conjunction with the drawings.

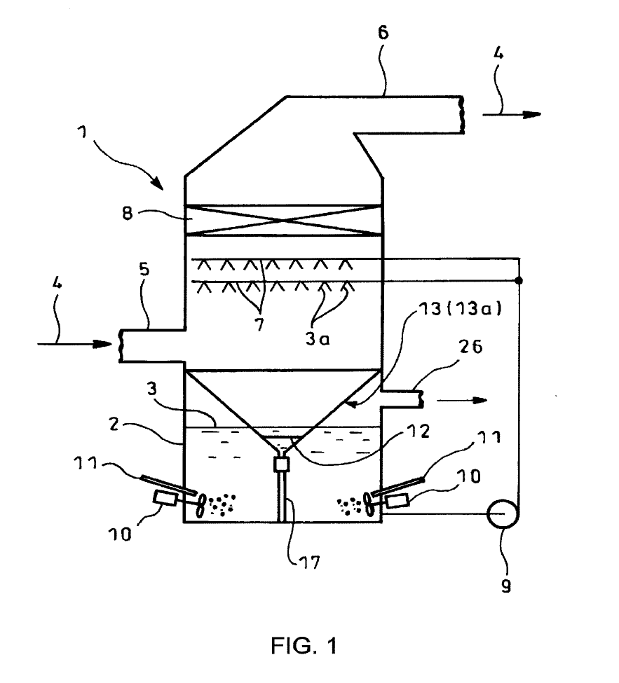

FIG. 1 shows the embodiment of a desulfurization device (wet-type desulfurization device) according to the disclosure applied to an oxyfuel combustion coal boiler as an oxyfuel combustor in which reference numeral 1 denotes an absorbing column with a lower portion which provides a reservoir 2. Reference numeral 3 designates absorption liquid stored in the reservoir 2.

A side wall of the absorbing column 1 above the reservoir 2 is formed with an exhaust gas inlet 5 for introduction of exhaust gas 4 from the oxyfuel combustion coal boiler (not shown) and an upper end of the absorbing column 1 is formed with an exhaust gas outlet 6 for discharge of the exhaust gas 4. Arranged in the absorbing column 1 above the exhaust gas inlet 5 is a spray unit 7 for injection of absorption liquid 3a and arranged above the spray unit 7 is a mist eliminator 8. The spray unit 7 is supplied with the absorption liquid 3 from the reservoir 2 by a circulation pump 9.

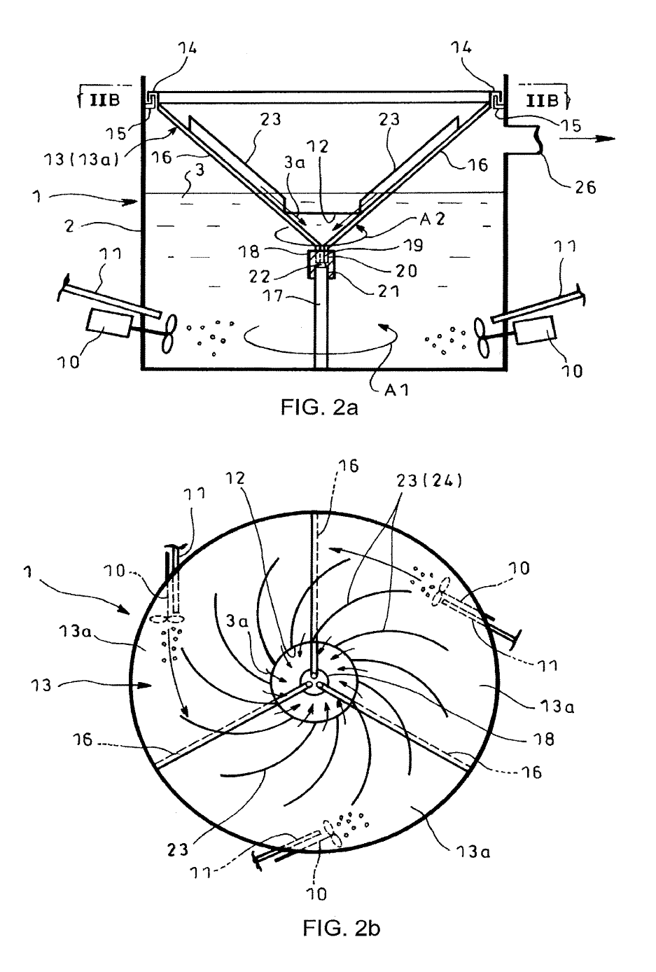

As shown in FIGS. 2a and 2b, the reservoir 2 is peripherally inwardly provided with stirrers 10 which stir the absorption liquid 3 to prevent limestone particles therein from depositing. FIG. 2b shows a case where three stirrers 10 are arranged to stir the absorption liquid 3 peripherally in a same direction. By the stirrers 10 directed in the same direction, the absorption liquid 3 in the reservoir 2 is swirled in a constant direction A1.

Arranged adjacent to the stirrers 10 are air supply pipes 11, respectively, which blow oxidizing air into the absorption liquid 3. The air supply pipes 11 are such that the oxidizing air blown from the air supply pipes 11 is sucked by the stirrers 10 and is dispersed into the absorption liquid 3.

As shown in FIGS. 1, 2a and 2b, arranged in the absorbing column 1 between the spray unit 7 and the reservoir 2 is a liquid collection plate 13 which has a hollow frustoconical shape with a descending slope from an outer periphery thereof toward an axis thereof. The liquid collection plate 13 has an axial bottom with an opening 12 immersed in the absorption liquid 3 in the reservoir 2. The liquid collection plate 13 is made from anticorrosion material such as stainless steel for prevention of corrosion.

The liquid collection plate 13 is peripherally divided into and is formed by a plurality of divisional plates 13a as shown in FIG. 2b which shows a case where the liquid collection plate 13 is peripherally divided into three divisional plates 13a in the form of fans.

Each of the divisional plates 13a has an outer upper end with a hook 14 extending arcuately and bent downward; the absorbing column 1 has an inner surface with an upwardly formed latch 15. The outer upper ends of the divisional plates 13a are supported by the absorbing column 1 through engagement of the hooks 14 with the latch 15.

Each of the divisional plates 13a in the form of fans has a radially extending side 25a to which a reinforcing frame 16 is fixed. The reinforcing frame 16 is made from anticorrosion material such as stainless steel for prevention of corrosion.

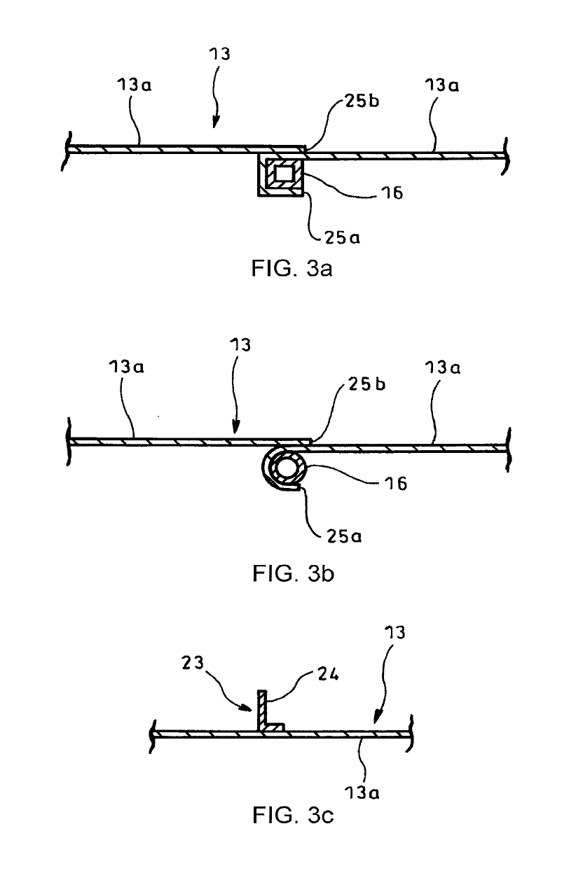

The reinforcing frame 16 may be in the form of a rectangular or cylindrical tube as shown in FIG. 3a or 3b or may be of any other shape. The reinforcing frame 16 may be arranged along the radially extending side 25a of the divisional plate 13a in the form of the fan and may be fixed to the divisional plate 13a such that the side 25a is wrapped around and welded to the reinforcing frame 16.

As shown in FIGS. 1, 2a and 2b, vertically and axially fixed to a bottom of the reservoir 2 is a brace 17 which supports the lower ends of the reinforcing frames 16.

In the embodiment shown in FIGS. 2a and 2b, arranged on an upper end of the brace 17 is a connecting member 18 through which lower ends of the reinforcing frames 16 for the divisional plates 13a are supported by the brace 17. An upper end of the connecting member 18 is formed with an upper opening 20 for insertion of the inserts 19 provided by vertically bending the lower ends of the reinforcing frames 16, and a lower end of the connecting member 18 is formed with a lower opening 21 into which inserted is the upper end of the brace 17. Within the connecting member 18, the upper opening 20 is communicated with the lower opening 21 to provide a communication port 22 suitable for removal of gypsum solidified inside. The communication port 22 is formed to provide communication between the upper and lower openings 20 and 21 and restrict the inserted positions of the inserts 19 and brace 17. Explained in the embodiment shown in FIGS. 2a and 2b is a case where the inserts 19 provided by the lower ends of the reinforcing frames 16 on the divisional plates 13a are inserted into and supported by the upper opening 20 of the connecting member 18 mounted on the brace 17; alternatively, the inserts 19 of the reinforcing frames 16 may be directly inserted into and supported by an upper opening (not shown) provided on the brace 17.

As shown in FIG. 3a or 3b, the other side 25b (the side without the reinforcing frame 16) of each of the divisional plates 13a in the form of the fans is rested on and supported by the one side 25a with the reinforcing frame 16.

Arranged on an upper surface of the liquid collection plate 13 are liquid-guiding projections 23 through which the absorption liquid 3a injected from the spray unit 7 is swirled in a direction A2 same as the direction A1 of swirl of the absorption liquid 3 in the reservoir 2 by the stirrer 10 and is guided to the opening 12. As shown in FIG. 3c, the liquid-guiding projections 23 may be liquid-guiding plates 24 curved to have L-shaped sections; a one side of each of the liquid-guiding plates 24 is fixed to the upper surface of the liquid collection plate 13 by welding to stand the other side of the same. The liquid-guiding plate 24 is made from anticorrosion material such as stainless steel for prevention of corrosion. Though the description is made on a case where the liquid-guiding plates 24 constituting the liquid-guiding projections 23 have the L-shaped sections, they may have any other shapes provided that they are projected on the upper surface of the liquid collection plate 13 by a predetermined height and can guide the absorption liquid 3 to the opening 12.

FIG. 2b shows a case where the liquid-guiding plates 24 are curved plates such that the absorption liquid 3a injected from the spray unit 7 can be swirled in the direction A2 same as the direction A1 of swirl of the absorption liquid 3 in the reservoir 2 by the stirrers 10 and guided to the opening 12.

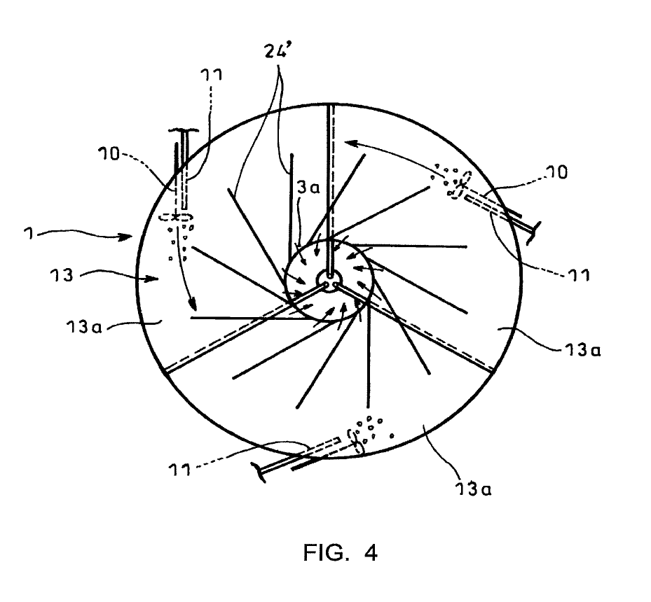

Alternatively, the liquid-guiding plate 24 may be straight liquid-guiding plate 24′ extending tangentially to the opening 12 as shown in FIG. 4 since it suffices that the absorption liquid 3a injected from the spray unit 7 can be swirled in the direction A2 same as the direction A1 of swirl of the absorption liquid 3 in the reservoir 2 by the stirrers 10 and can be guided to the opening 12.

The side wall of the absorbing column 1 between an upper surface of the absorption liquid 3 in the reservoir 2 and the outer upper end of the liquid collection plate 13 is formed with an air outlet 26 for discharge of the air outside after the oxidization.

Next, an operation of the above embodiment will be described.

Upon arrangement of the liquid collection plate 13 within the absorbing column 1 shown in FIGS. 1, 2a and 2b, the hooks 14 on the arcuate outer upper ends of the plurality of divisional plates 13a are engaged with the latch 15 fixed on the inner surface of the absorbing column 1 so that the outer upper ends of the divisional plates 13a are supported by the absorbing column 1. The inserts 19 provided by curving vertically downward the lower ends of the reinforcing frames 16 fixed on the respective divisional plates 13a are inserted into the upper opening 20 on the upper end of the connecting member 18 on the upper end of the brace 17 fixed to the bottom of the reservoir 2. Thus, the inner lower ends of the divisional plates 13a are supported by the brace 17. In this case, the other side 25b of each of the divisional plates 13a in the form of fans (the side without the reinforcing frame 16) is rested on and supported by the one side 25a with the reinforcing frame 16 as shown in FIGS. 3a and 3b. The provision of the above-mentioned liquid collection plate 13 partitions the upper inside of the absorbing column 1 and the inside of the reservoir 2.

The exhaust gas 4 from the oxyfuel combustion coal boiler (not shown) is introduced through the exhaust gas inlet 5 into the absorbing column 1 and is contacted with the absorption liquid 3a injected from the spray unit 7 so that dust and sulfur in the exhaust gas are captured and dropped to the liquid collection plate 13. In this case, it suffices that liquid collection plate 13 receives and guides the absorption liquid 3a injected from the spray unit 7 into the absorption liquid 3 in the reservoir 2 through the opening 12, which makes it possible to employ a structure simple and light in weight.

The absorption liquid 3a dropped to the liquid collection plate 13 is collected axially by the liquid-guiding plates 24 constituting the liquid-guiding projections 23 on the upper surface of the liquid collection plate 13 and the absorption liquid 3a collected axially is caused to flow through the opening 12 immersed in the absorption liquid 3 in the reservoir 2 into the absorption liquid 3 in the reservoir 2.

In this case, arranged on the upper surface of the liquid collection plate 13 are the liquid-guiding projections 23 constituted by the liquid guiding plates 24 which swirl the absorption liquid in the direction A2 same as the direction A1 of swirl of the absorption liquid 3 in the reservoir 2 by the stirrers 10 and guide the same into the opening 12. Thus, the absorption liquid 3a dropped to the liquid collection plate 13 is swirled and directed to the opening 12.

Thus, the absorption liquid 3a on and above the liquid collection plate 13 is swirled by liquid collection plate 13 and is caused to flow through the opening 12 into the absorption liquid 3 in the reservoir 2 so that the flow of the absorption liquid 3a into the absorption liquid 3 prevents the oxidizing air blown from the air supply pipes 11 from being directed to an inner upside of the absorbing column 1. Thus, prevented is admixing of the air into the exhaust gas 4 in the absorbing column 1 mainly constituted by carbon dioxide.

Though the other side 25b of the divisional plate 13a is merely rested on the one side 25a, any space between the other and one sides 25b and 25a is clogged by gypsum as soon as the operation of the absorbing column 1 is started, so that the air in the reservoir 2 is prevented from being leaked through the liquid collection plate 13 into the inner upside in the absorbing column 1.

The absorption liquid 3a on and above the liquid collection plate 13 is swirled in the direction A2 same as the direction A1 of swirl of the absorption liquid 3 by the stirrers 10 and flows through the opening 12 into the absorption liquid 3 in the reservoir 2, which enhances an effect of stirring the absorption liquid 3 in the reservoir 2. Such enhanced effect of stirring the absorption liquid 3 enhances an effect of oxidizing the sulfur dioxide in the absorption liquid 3. Further, swirl and flow of the absorption liquid 3a on and the above the liquid collection plate 13 through the opening 12 into the absorption liquid 3 in the reservoir 2 can prevent limestone particles from being deposited on and adjacent to the brace 17 on the axis of the reservoir 2.

The absorption liquid 3a flowing through the opening 12 into the reservoir 2 has been swirled in the direction A2 same as the direction A1 of swirl of the absorption liquid 3 by the stirrers 10, which promotes the swirl of the absorption liquid 3 by the stirrers 10 and thus relieves load for stirring the absorption liquid 3 by the stirrers 10.

Next, maintenance work of the absorbing column 1 will be described.

For the maintenance work of the absorbing column 1 shown in FIGS. 1, 2a and 2b, the absorption liquid 3 within the reservoir 2 is wholly removed. Then, the hooks 14 on the outsides of the divisional plates 13a are dragged away from the latch 15 on the absorbing column 1 and the inserts 19 provided by the lower ends of the reinforcing frames 16 are dragged out of the upper opening 20 on the connecting member 18 to thereby dismount all of the divisional plates 13a. The divisional plates 13a dismounted are leaned against and secured to the brace 17.

As mentioned in the above, the divisional plates 13a can be easily dismounted by dragging the hooks 14 away from the latch 15 on the absorbing column 1 and dragging the inserts 19 provided by the lower ends of the reinforcing frames 16 out of the upper opening 20 on the connecting member 18. The connecting member 18 is formed with the communication port 22 for communication between the upper and lower openings 20 and 21 so that any gypsum solidified within the connecting member 18 at the upper and lower openings 20 and 21 can be easily removed.

Next, the scaffolding is assembled along the inner surface of the absorbing column 1 flattened by dismounting the divisional plates 13a. Then, the assembled scaffolding is utilized to conduct the work for removing any gypsum adhering to the inner surfaces of the reservoir 2 and absorbing column 1 as well as to the spray unit 7. Further, any corrosion state of the inner surfaces of the reservoir 2 and absorbing column 1 as well as of the spray unit 7 is inspected and repair work is conducted to any portions to be repaired.

As mentioned in the above, the divisional plates 13a are dismountable so that the inner surface of the absorbing column 1 is flattened by dismounting the divisional plates 13a, which facilitates assembling the scaffolding within the absorbing column 1, gypsum removal, inspection of corrosion state and repair. Thus, effort for the maintenance work of the desulfurization device can be relieved to drastically reduce a cost for the maintenance work.

It is to be understood that a desulfurization device according to the disclosure is not limited to the above embodiment and that various changes and modifications may be made without departing from the scope of the disclosure.

### REFERENCE SIGNS LIST

1 absorbing column
2 reservoir
3 absorption liquid
3a absorption liquid
4 exhaust gas
7 spray unit
10 stirrer
11 air supply pipe
12 opening
13 liquid collection plate
13a divisional plate
14 hook
15 latch
16 reinforcing frame
17 brace
18 connecting member
19 insert
20 upper opening
23 liquid-guiding projection

1. A desulfurization device comprising
an absorbing column into which introduced is exhaust gas from an oxyfuel combustor, the absorbing column comprising a spray unit, a reservoir for storing absorption liquid injected from the spray unit and contacted with the exhaust gas, a stirrer for stirring and swirling the absorption liquid in the reservoir peripherally and an air supply pipe for blowing oxidizing air into the absorption liquid in the reservoir and
a liquid collection plate arranged in the absorbing column between the spray unit and the reservoir, the liquid collection plate having a hollow frustoconical shape with a descending slope from an outer periphery thereof toward an axis thereof and having an axial bottom with an opening positioned in the absorption liquid of the reservoir,
the liquid collection plate being peripherally divided into and formed by a plurality of divisional plates, each of the divisional plates having an outer upper end with a hook supported by a latch on an inner surface of the absorbing column and having an inner lower end supported by a brace fixed to a bottom of the reservoir.

2. The desulfurization device as claimed in claim 1, wherein liquid-guiding projections are arranged on an upper surface of the liquid collection plate to swirl the absorption liquid injected from the spray unit in a direction same as that of swirl of the absorption liquid in the reservoir by the stirrers and guide the absorption liquid into the opening.

3. The desulfurization device as claimed in claim 1, wherein a radially extending reinforcing frame is fixed on each of the divisional plates and has a lower end extending beyond the inner lower end of the corresponding divisional plate to provide an insert which is inserted into and supported by an upper end of the brace.

4. The desulfurization device as claimed in claim 3, wherein liquid-guiding projections are arranged on an upper surface of the liquid collection plate to swirl the absorption liquid injected from the spray unit in a direction same as that of swirl of the absorption liquid in the reservoir by the stirrers and guide the absorption liquid into the opening.
